(19) United States
(12) Patent Application Publication
(10) Pub. No.: US 2014/0195582 A1
(43) Pub. Date: Jul. 10, 2014

(54) SYSTEM AND METHOD FOR PROVIDING AN INTER-APPLICATION COMMUNICATION FRAMEWORK

(71) Applicant: PacketVideo Corporation, San Diego, CA (US)

(72) Inventors: Greg Sherwood, Inverness, IL (US); Osama Al-Shaykh, San Diego, CA (US); Dann Wilkens, Cardiff, CA (US); Ralph Neff, San Diego, CA (US)

(73) Assignee: PacketVideo Corporation, San Diego, CA (US)

(21) Appl. No.: 13/738,219

(22) Filed: Jan. 10, 2013

(51) Int. Cl. H04L 29/08

(52) U.S. Cl. CPC H04L 67/10
USPC 709/201

(57) ABSTRACT

A system and a method provide an inter-application communication framework. A first application executed on a first device may establish communication and/or interaction with a second application executed by a second device and compatible with the first application. The first device may be connected to the second device by a network which enables the communication between the first application and the second application. The first device may support different application frameworks relative to the second device, and the first application and the second application may exist in different application frameworks. The first device may query an application knowledge repository to determine one or more compatible applications which exist in an application framework supported by the second device. In response, the first device may obtain identifiers which may identify the compatible applications in the application framework supported by the second device.

### BACKGROUND OF THE INVENTION

The present invention generally relates to a system and a method which provide an inter-application communication framework. More specifically, a first application executed on a first device may establish communication and/or interaction with a second application running on a second device and compatible with the first application.

Personal computers have supported installable software applications for decades. However, a more recent development is that non-traditional computing devices are often equipped with application frameworks. These non-traditional computing devices include mobile telephones, media players, personal digital assistants, tablet computers, gaming consoles, networked televisions, media adapters, and/or the like. When such devices are connected to a network, applications may be downloaded, installed and used on these devices. In many devices, applications may be discovered and downloaded to the device from a default application store. In some cases, applications are distributed for free, while in other cases, applications must be purchased.

Different devices may utilize different application frameworks. For example, some smartphones and other devices use the Android (trademark of Google Inc.) operating system. Such devices are capable of running Android applications, many of which are available through an application store called the “Android Market.” The Android Market is typically accessed through an application which is pre-loaded on most Android devices before they are sold. Other devices use Apple's iOS (trademark of Cisco Systems, Inc.) operating system. Such devices are capable of running iOS applications, many of which are available from an application store called “the App Store” operated by Apple. Access to the App Store is a standard feature of Apple devices, such as the iPhone, the iPod Touch and the iPad (trademarks of Apple Inc.).

Other devices have access to other application frameworks. For example, Samsung Electronics Co., Ltd. operates an application store which provides applications which run on some Samsung televisions and Samsung Blu-ray players. Vizio, Inc. provides an application store called “V.I.A.” (trademark of Vizio, Inc.) which provides applications to some Vizio televisions and Vizio Blu-ray players. Some media adapters, such as Google TV (trademark of Google Inc.) and Roku (trademark of Roku, Inc.), support downloadable applications. Google TV runs a variant of the Android operating system; however, Google TV effectively has a separate application framework from other Android devices because Google TV only runs applications developed to run on Google TV hardware. Roku operates the Roku Channel Store which provides applications to the Roku media adapters. Additionally, gaming devices, such as the Wii (trademark of Nintendo of America Inc.), the Xbox (trademark of Microsoft Corporation), and Playstation 3 (trademark of Sony Computer Entertainment Inc.), each have their own application framework and associated application store.

Therefore, a user may use different devices which offer application frameworks. The user may discover, download, install and use applications within a single device. Moreover, the applications available on a single device may be capable of communicating and/or interworking with each other within the device using application programming interfaces and communication channels provided by the device operating system.

However, communication between applications on different devices is limited, especially if the different devices have different operating systems and/or different application frameworks. “Application Framework” is used herein as a capability of a device or a class of devices to download, install and run applications. An application developed for a first application framework may generally be compatible with devices designed to support the first application framework. However, other devices designed to support a second application framework different than the first application framework typically will not support the application developed for the first application framework.

An application provider may provide different versions of an application, and each of the versions may correspond to one of the different application frameworks. In this way, the application provider may deploy the application in different versions to devices across the application framework boundaries. However, this approach requires that the application providers develop and maintain the various versions. Moreover, this approach requires that the application providers address the different distribution channels, namely the different application stores which service the different application frameworks.

Because of the limitations described above, communication and/or interaction between applications on different devices is often limited to certain pre-defined functions based on well-known interaction protocols. However, such communication and/or interaction may require that the applications are already installed on the devices. Further, such communication and/or interaction may require that the applications are already running on the devices. Still further, such communication and/or interaction may require that the applications mutually support some pre-defined discovery protocol by which a first application running on a first device may discover the existence of a second application running on a second device. Moreover, such communication and/or interaction may require that the applications mutually support some pre-defined communication protocol which defines how the applications may exchange data and to what effect. For example, Universal Plug and Play (“UPnP,” trademark of UPnP Implementers Corporation) defines standard protocols by which devices or applications running on devices may discover each other, may determine capabilities of each other, and may communicate for some pre-defined purpose. Digital Living Network Alliance (“DLNA,” trademark of Digital Living Network Alliance) builds on the UPnP standards to allow devices or applications running on devices to communicate for the purpose of accessing and/or controlling multimedia content in a network. Thus, a DLNA Control Point Application running on a first device may utilize UPnP discovery protocols in a network in an attempt to discover and interact with other DLNA-compatible applications running on other devices. However, such actions are generally effective only if DLNA-compatible applications are already present and installed on the other devices. Moreover, such actions are generally effective only if such applications are already running on the other devices at the time the DLNA Control Point Application on the first device attempts to discover and communicate with other DLNA-compatible applications.

If DLNA-compatible applications are not already present, installed and running on the various devices, then the user may have an initial burden to visit each device, explore the application store accessible from each device, and then discover, download, and install an appropriate DLNA-compatible application on each device before the various devices may communicate using DLNA. Moreover, the user may have the ongoing burden to ensure that the applications are running on each device at the time the user wishes to make use of DLNA interactivity. In addition, the user may have an ongoing burden to periodically maintain and/or update the applications on each of the devices.

DLNA and its associated discovery and communication protocols are an example of a class of applications designed for a specific purpose. Many other cases involve a first application running on a first device which may usefully communicate with and/or interact with a second application running on a second device. Such communication and/or interaction provides additional burden to the user because the user must meet the installation, run time and maintenance burdens previously discussed and must meet these burdens for each class of interacting applications. Such communication and/or interaction also provides additional burden to the application developers because the logic for discovery and communication is customized for each application in a class of applications. Thus, a particular device may have multiple installed applications which each have their own discovery and communication protocols designed for interaction within a different application class.

### SUMMARY OF THE INVENTION

The present invention generally relates to a system and a method which provide an, inter-application communication framework. More specifically, a first application executed on a first device may establish communication and/or interaction with a second application executed by a second device and compatible with the first application. The first device may be connected to the second device by a network which enables the communication between the first application and the second application. The first device may support a different application framework relative to the second device, and the first application and the second application may exist in different application frameworks.

To this end, a system to provide inter-application communication in a network is provided. The system has a network with an application knowledge repository connected thereto. The application knowledge repository stores records having application identifiers corresponding to different versions of applications available for different application frameworks. The system also has a control device connected to the network. The control device transmits a query to the application knowledge repository. The query identifies a first application identifier corresponding to the version of a first application compatible with a first application framework. The query also identifies a second application framework different than the first application framework. The application knowledge repository returns a query response to the control device identifying a second application identifier corresponding to the version of the first application compatible with the second application framework.

In an embodiment, the system has universal identifiers corresponding to each of the applications with which the first application is capable of interacting. The application knowledge repository stores the universal identifiers.

In an embodiment, the records specify application classes to which the applications belong.

In an embodiment, the application knowledge repository receives the records from an application provider.

In an embodiment, the application knowledge repository acquires the records from an application store.

In an embodiment, the application knowledge repository returns a query response to the control device identifying a source location of the first application.

In an embodiment, the system has a first device connected to the network. The control device queries the application knowledge repository to determine an application identifier appropriate to the first device.

In another embodiment of the present invention, a method of inter-application communication in a network is provided. The method has the step of running a first application on a control device to discover a first device in the network. The first device supports a first application framework. The method also has the step of querying an application knowledge repository with the control device. The query specifies a first application identifier. The method further has the step of receiving a query response by the control device. The query response specifies a second application identifier corresponding to the first application identifier. The second application identifier identifies a second application available in the first application framework. The method also has the step of sending a first message to the first device from the first application specifying the second application identifier. Finally, the method has the step of installing the second application on the first device in response to the first message. The first device installs the second application.

In an embodiment, the method has the steps of sending a second message to the first device from the first application specifying the second application identifier, and running the second application on the first device in response to the second message.

In an embodiment, the method also has the step of communicating application frameworks supported by the first device to the control device. The first device informs the control device of the application frameworks supported by the first device.

In an embodiment, the application identifier used in the query is a universal application identifier. The universal application identifier does not correspond to a specific application framework.

In an embodiment, the first application identifier specifies the first application running on the control device, and the second application identifier identifies a different version of the first application for the first application framework.

In an embodiment, the method also has the step of requesting a status of the first device by the control device. The status specifies whether a particular application is installed on the first device.

In an embodiment, the method also has the step of requesting a status of the first device by the control device. The status specifies whether a particular application is running on the first device.

In an embodiment, the control device does not support the first application framework that the first device supports.

In an embodiment, the method also has the steps of requesting a status of an application on the first device by the control device, and communicating a warning to a user of the first device requesting input from the user. The first device communicates the warning to the user in response to the status request.

In an embodiment, the method also has the step of authorizing a response to the control device by user input on the first device.

In an embodiment, the query specifies multiple application identifiers, and the query response specifies multiple application identifiers which correspond to more than one application available for the first application framework.

In an embodiment, the application knowledge repository is incorporated into the control device.

In an embodiment, the application knowledge repository is located on a second device accessible to the control device via the network.

In an embodiment, the method also has the step of exchanging data between the first application running on the control device and an instance of the second application running on the first device.

In a further embodiment of the present invention, a method of inter-application communication in a network having a control device is provided. The method has the steps of detecting a first device with the control device, and querying an application knowledge repository with the control device to determine an application appropriate to the first device. The application knowledge repository transmits a query response to the control device. The method also has the step of installing an application on the first device. The application is identified in the query response. The control device communicates with the first device to install the application.

In another embodiment of the present invention, a method of inter-application communication in a network having a control device is provided. The method has the step of running a first application on the control device to discover a first device in the network. The first device supports a first application framework. The method has the step of querying an application knowledge repository with the control device. The query specifies an application class and the first application framework. The method also has the step of identifying an application which belongs to the application class and is available for the first application framework specified in the query. Further the method has the step of providing a query response to the control device from the application knowledge repository specifying application identifiers for applications which belong to the application class and which are available for the first application framework specified in the query. Finally, the method has the step of installing an application on the first device. The application is one of the applications for which an application identifier was specified in the query response. The control device communicates with the first device to install the application.

In an embodiment, the query specifies at least two application classes to determine the applications from each application class which are available for application frameworks supported by the first device. The query response to the control device from the application knowledge repository specifies application identifiers for the applications which belongs to each of the at least two application classes specified in the query. The method further has the step of instructing the first device to install an available application from each of the at least two application classes. The available applications installed on the first device support interaction with the first application.

In an embodiment, the query specifies at least two application classes to determine the applications from each application class which are available for application frameworks supported by the first device. The query response to the control device from the application knowledge repository specifies an application identifier for a single application which belongs to both of the at least two application classes specified in the query. The method also has the step of instructing the first device to install the single application which belongs to both of the at least two application classes specified in the query.

In yet another embodiment of the present invention, a method of updating devices in a network is provided. The method has the steps of running a first application on a control device, and identifying a plurality of devices in the network using the control device. Each of the plurality of devices is capable of running applications from an application framework supported by each respective device. The method also has the step of querying an application knowledge repository using the control device to obtain application identifiers for applications appropriate to the respective application frameworks supported by each of the plurality of devices. Further, the method has the step receiving a query response from the application knowledge repository by the control device. The query response provides the application identifiers. The method also has the step of requesting a status from each of the plurality of devices using the control device. The request for status sent to each device specifies one of the application identifiers provided in the query response. The method also has the step of receiving a message from each of the plurality of devices by the control device. Each respective message provides the status of the application corresponding to the application identifier for which the request for status was sent to each respective device. Also, the method has the step of displaying information on the control device indicating which of the plurality of devices do not have the application specified by the application identifier installed. The method further has the step of requesting installation of an application on one of the plurality of devices. Finally, the method has the step of installing applications on the one of the plurality of devices in response to the installation request.

In an embodiment, one of the plurality of devices supports an application framework which is not supported by the control device.

In an embodiment, the query specifies a plurality of application identifiers. The application identifiers provided to the control device in the query response correspond to a subset of the plurality specified in the query.

In an embodiment, the method has the step of determining a subset of the plurality of devices to request installation of an application in response to user input on the control device.

In an embodiment, the query specifies an application class.

In an embodiment, the query specifies an application identifier.

In an embodiment, method has the step of communicating with one of the plurality of devices using the control device to identify a version of an operating system on the device. The method also has the step of querying the application knowledge repository with the control device to obtain a list of application identifiers. The control device indicates the version of the operating system in the query. The method also has the step of comparing the version of the operating system indicated in the query to an operating system version compatibility specification in the application knowledge repository. Finally, the method has the step of responding to the query. The application knowledge repository specifies for the one of the plurality of devices only those application identifiers which correspond to application versions which are compatible with the version of the operating system indicated by the device.

In an embodiment, the message received from each device indicates whether the application corresponding to the application identifier for which status was requested is installed on the device.

In an embodiment, the message received from each device indicates whether the application corresponding to the application identifier for which status was requested is running on the device.

It is, therefore, an advantage of the present invention to provide an inter-application communication framework.

Another advantage of the present invention is to provide a system and a method which enable an application on a first device to determine whether a particular application exists in the application framework supported by a second device.

And, another advantage of the present invention is to provide a system and a method which enable an application on a first device to determine whether a particular application is currently installed on a second device.

A further advantage of the present invention is to provide a system and a method which enable a first application on a first device to request that a second application be run on a second device.

Another advantage of the present invention is to provide a system and a method which enable an application on a first device to request installation of an application on a second device which may have a different application framework than the first device.

Yet another advantage of the present invention is to provide a system and a method which enable data exchange between applications on different devices which may have different application frameworks.

A further advantage of the present invention is to provide a system and a method which implement a common inter-application discovery and/or communication process into the application frameworks and/or into the device operating systems of different devices which may have different application frameworks.

Another advantage of the present invention is to provide a system and a method which determine whether a specific application with which a first application wishes to interact is available for an application framework supported by a second device and then respond to unavailability by using a list of candidate applications with which the first application may interact to determine the availability of the candidate applications in the application framework supported by the second device.

Yet another advantage of the present invention is to provide a system and a method which determine whether a specific application with which a first application wishes to interact is available for an application framework supported by a second device and then respond to unavailability by using a class of applications with which the first application may interact to determine the availability of applications in the class in the application framework supported by the second device.

Another advantage of the present invention is to provide a system and a method which enable a first application on a first device to determine which devices in a local network are lacking compatible applications, determine which candidate applications are available for each of the devices which lack the compatible applications, and request that each of the devices which lack the compatible applications install one of the appropriate candidate applications.

Another advantage of the present invention is to provide a system and a method in which a first application running on one device may cause installation of compatible applications on other devices so that the utility of the first application and/or the utility of the network overall may be improved.

And, another advantage of the present invention is to provide an inter-application framework which securely shares interactions and information.

Yet another advantage of the present invention is to provide a system and a method which hinder or prevent an application on a first device from obtaining information about the applications present and/or running on a second device without approval from a user or an administrator of the second device.

A further advantage of the present invention is to provide a system and a method which hinder or prevent a second device from installing and/or running applications at the request of an application on a first device without approval from a user or an administrator of the second device.

Additional features and advantages of the present invention are described in, and will be apparent from, the detailed description of the presently preferred embodiments and from the drawings.

### BRIEF DESCRIPTION OF THE DRAWINGS

FIG. 1 illustrates a black box diagram of a system for providing an inter-application framework in an embodiment of the present invention.

FIG. 2 illustrates records which may be stored by an application knowledge repository in an embodiment of the present invention.

FIGS. 3, 4a, 4b and 5 illustrate methods in embodiments of the present invention.

FIG. 6 illustrates a user interface for providing an inter-application framework in an embodiment of the present invention.

### DETAILED DESCRIPTION OF THE PREFERRED EMBODIMENTS

The present invention generally relates to a system and a method which provide an inter-application communication framework. More specifically, a first application executed on a first device may establish communication and/or interaction with a second application executed by a second device and compatible with the first application. The first device may be connected to the second device by a network which enables the communication between the first application and the second application.

The first device may support a different application framework relative to the second device, and the first application and the second application may exist in different application frameworks.

The first device may query an application knowledge repository to determine one or more compatible applications which exist in an application framework supported by the second device. In response, the first device may obtain identifiers which may identify the compatible applications in the application framework supported by the second device. The first device may use the identifiers to query the second device to determine whether one or more of the compatible applications is installed on and/or executed by the second device. The first device may request that the second device install and/or execute one or more of the compatible applications. The first application may then communicate and/or interact with one or more compatible applications executed by the second device.

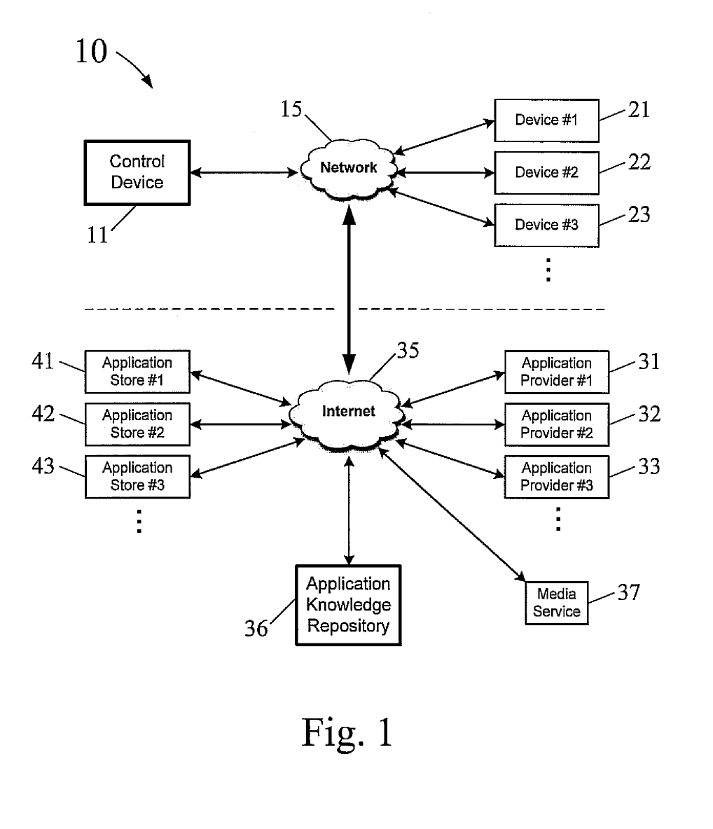

FIG. 1 generally illustrates a system 10 in an embodiment of the present invention. A control device 11 may be connected to one or more other devices, such as a first device 21, a second device 22 and/or a third device 23, over a network 15. FIG. 1 depicts three other devices; however, the system 10 may have any number of other devices, and the present invention is not limited to a specific number of other devices.

The network 15 may be and/or may include a local area network, such as an office network or a home network. Alternatively or additionally, the network 15 may be and/or may include a wide area network, such as a mobile carrier network. The network 15 may be composed of multiple interconnected networks. The network 15 may be any network known to one skilled in the art, and the present invention is not limited to a specific embodiment of the network 15.

The network 15 may use one or more network connection technologies to connect the control device 11 and the other devices, such as the first device 21, the second device 22 and/or the third device 23. The network connection technologies may be wired or wireless. For example, the network connection technologies may include Ethernet wiring, 802.11 wireless connections, multimedia over coax (“MoCa,” trademark of Multimedia Over Coax Alliance, Inc.) connections, HomePlug (trademark of the HomePlug Powerline Alliance, Inc.) connections, mobile wireless carrier connections, WiMax (trademark of WiMAX Forum) connections, and/or the like. The network 15 may support standard packet-based communication protocols, such as IP, TCP, UDP, RTP, HTTP, and/or the like.

The control device 11 may be capable of running applications from an application framework supported by the control device 11. Each of the other devices may be capable of running applications from an application framework supported by the corresponding device. For example, the first device 21 may be capable of running applications from an application framework supported by the first device 21, the second device 22 may be capable of running applications from an application framework supported by the second device 22, and/or the third device 23 may be capable of running applications from an application framework supported by the third device 23.

The devices may support different application frameworks. For example, the control device 11 may support a first application framework, and the first device 21 may support a second application framework which may be a different application framework than the first application framework. However, the second device 22 may support the first application framework. The system 10 may establish communication and/or interaction between applications on the control device 11 and one of the other devices regardless of whether the control device 11 and the other device share the same application framework or have different application frameworks.

Each of the control device 11 and the other devices may be any device capable of installing and running applications from an application framework. The control device 11 and the other devices may be a mobile telephone, a media player, a personal digital assistant, a tablet computer, a gaming console, a networked television, a networked optical disc player, a media adapter, a personal computer, a laptop computer, a netbook computer, and/or the like. For example, the control device 11 may be a smartphone, the first device 21 may be a networked television, the second device 22 may be a tablet computing device, and/or the third device 23 may be a gaming console. The present invention is not limited to specific embodiments of the control device 11 and the other devices, and the control device 11 and the other devices may be any devices capable of installing and running applications.

The application frameworks may include, for example, the Android application framework, Apple's iOS application framework, RIM's Blackberry application framework, Microsoft's Windows phone application framework, Samsung's TV application framework, Vizio's V.I.A. application framework, Google TV applications, Roku apps and/or channels, Wii applications, Xbox applications, Playstation applications, and/or the like. The application frameworks may be and/or may include any application framework known to one skilled in the art, and the present invention is not limited to specific application frameworks.

The applications may be created, developed, provided, and/or licensed by application providers, such as a first application provider 31, a second application provider 32 and/or a third application provider 33. FIG. 1 depicts three application providers; however, the system 10 may have any number of application providers, and the present invention is not limited to a specific number of application providers.

Each of the application providers may provide one or more applications. Each provider may provide applications to one or more application frameworks. For example, the first provider 31 may provide a single application, such as “MyNetworkPro,” and may provide different versions of the application which function in three different application frameworks, such as Android, iOS and/or Google TV. The second provider 32 may provide multiple different applications, such as a media application, a calendar application, and/or a photo editing application, and may provide the multiple different applications only to a single application framework, such as iOS. The third provider 33 may license porting and distribution rights of one of the applications of the second provider 32, such as the photo editing application. As a result, the third provider 33 may provide one of the applications of the second provider 32 to application frameworks not supported by the second provider 32, such as Android and Samsung TV. The system 10 may have a multitude of application providers, and each application provider may decide which applications to create, develop, license and/or provide and may decide which application frameworks are supported for each application.

Each application framework may have one or more associated application stores. The application provider may publish an application to an application store to make the application available to end user devices, such as the control device 11 and/or the other devices, such as the first device 21, the second device 22 and/or the third device 23. For example, the first provider 31 may publish one version of an application to a first application store 41, such as “Android Market,” which may be associated with a first application framework, such as “Android.” The first provider 31 may publish a second version of the application to a second application store 42, such as “Apple's App Store,” which may be associated with a second application framework, such as “iOS.” Publication of the application to an application store may have associated terms by which the application store may distribute and/or may sell the application to end users. In some cases, the terms may include remuneration paid to the application provider.

The application store may maintain one or more identifiers for each of the applications available from the application store. The identifiers may identify the application and/or the version of the application. The identifiers may be used by an end user device to identify the application in communication exchanges between the end user device and the application store. An identifier for an application may be and/or may include, for example, a unique ID number, a unique alphanumeric string, a URL, and/or the like. The identifier may be used in a request message from the end user device to identify a particular application. For example, the request message may request that the application store provides information about a particular application so that the end user device may display the information to a user who may be considering whether to download, install and/or purchase the application. As another example, the request message may request that a particular application be downloaded and/or purchased from the application store so that the application may be installed on the end user device.

The control device 11 may have a first application which may be capable of communicating with and/or interacting with other applications on other devices. The first application may be provided and/or stored by a non-transitory computer-readable medium executed by the control device 11, such as register memory, processor cache and Random Access Memory (RAM); the non-transitory computer-readable medium may be any computer-readable medium, the sole exception being a transitory, propagating signal.

The first application may have knowledge of the other applications with which the first application is capable of communicating and/or interacting. The knowledge may be and/or may include specific knowledge; for example, the control device 11 and/or the first application may have a list of one or more specific applications with which the first application is capable of communicating and/or interacting. Alternatively or additionally, the knowledge may be and/or may include non-specific knowledge; for example, the control device 11 and/or the first application may have a list of one or more classes of applications with which the first application is capable of communicating and/or interacting. For example, the class of applications may be “DLNA v1.5 compatible renderers” and/or the class of applications may be “RTSP media servers.” The class of applications may identify an application provider that provides the applications in the class; for example, the class of applications may be “ABC Software, Inc” where applications provided by ABC Software, Inc. support a known type of communication and/or interaction. The class of applications may identify a media service 37 associated with the applications. For example, the class of applications may identify the Petflix online video service, namely www.petflix.com, where the applications in the class are capable of displaying video content from the Petflix service. The control device 11 and/or the other devices may access the media service 37 over the network 15 and/or the internet 35. The class of applications may be any class identifier which may be used to identify applications which may support a specific type of communication and/or interaction.

In some embodiments, the first application on the control device 11 may have specific knowledge that the first application is capable of communicating with and/or interacting with another copy of the first application running on another device. In some embodiments, the first application on the control device 11 may have specific knowledge that the first application is capable of communicating with and/or interacting with one or more specific applications. The first application may have a list of these specific applications and/or identifiers for these specific applications. An identifier may be a universal identifier as discussed in more detail hereafter. Alternatively, an identifier may be specific to an application framework. For example, the identifiers may identify the specific applications in the application framework supported by the control device 11.

The list of specific applications may identify a preference for some specific applications over other applications. For example, the list may be arranged in a preference order which indicates that the first application may prefer to communicate and/or interact with the applications which are positioned earlier in the list relative to applications listed later in the list.

In an embodiment, the first application on the control device 11 may have a list of one or more application classes which may be used to identify applications with which the first application may communicate and/or interact. For each of the application classes in the list, the first application may have an application class identifier which identifies the application class. The application classes may be defined independently of any application framework. For example, a specific application class may be associated with a first application available for a first application framework, and the same application class may be associated with a second application available for a second application framework. Thus, a query which targets the specific application class may be matched to the first application if the query specifies the first application framework, and a query which targets the specific application class may be matched to the second application if the query specifies the second application framework.

The control device 11 may have access to an application knowledge repository 36 which may be located remotely relative to the control device 11 and/or the network 15. The control device 11 may access the application knowledge repository 36 over the network 15 and/or the internet 35. The application knowledge repository 36 may store records which indicate the availability of applications in the various application frameworks and may store the application identifier for each application framework in which the application is available. The application knowledge repository 36 may store additional information about each application, such as an application name, a description of the application, a version number, a source location, a provider name, an application store, an operating system compatibility specification, a list of one or more application classes, and/or the like.

The information may be stored for each version of the application and/or for each application framework for which the application is available. The source location may identify a location from which the application may be obtained; for example, the source location may identify a URL from which the application may be downloaded and/or purchased. The URL may direct to a particular location within an application store. The operating system compatibility specification may specify operating systems and/or operating system versions with which the application may be compatible. For example, the operating system compatibility specification may specify that an application which is available for Android devices may require the device to be running Android version 2.3 or later.

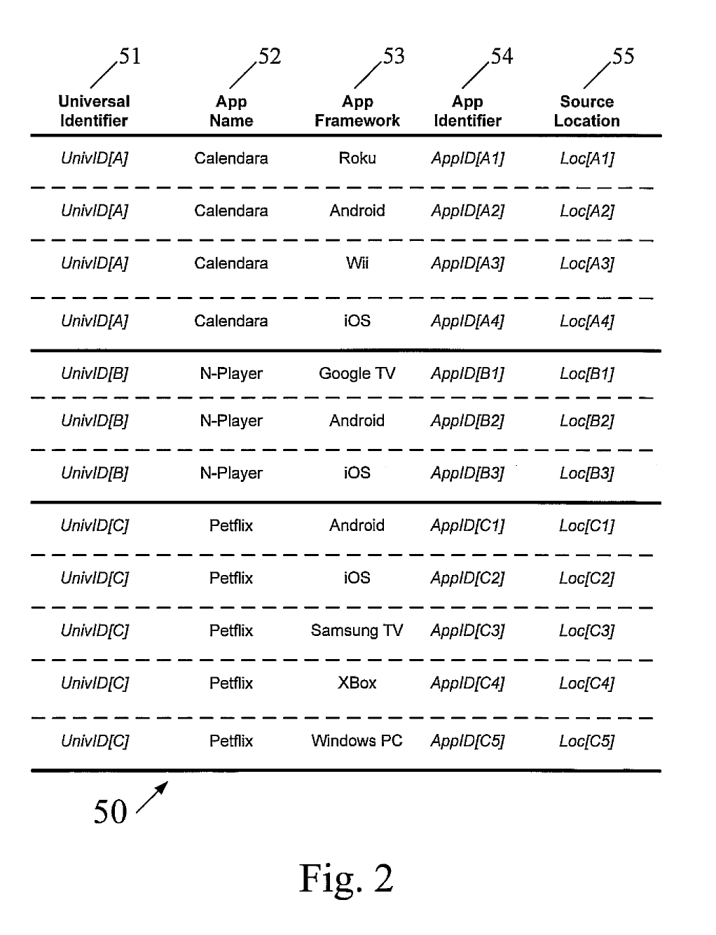

FIG. 2 illustrates an example of records 50 which may be stored by the application knowledge repository 36. The records 50 may describe applications across application framework boundaries. The records 50 are shown for three distinct applications, namely a personal calendar application “Calendara,” a media player application “N-Player,”and an application associated with a media service “Petflix.” Each of the applications may be associated with a universal identifier 51 which may be assigned by the provider of the application knowledge repository 36. However, some embodiments of the present invention do not require the universal identifier 51 as explained in further detail below. Each of the applications may have an application name 52 which may identify the application to a human user. A human-readable application description (not shown) may also be stored by the application knowledge repository 36. The records 50 may identify the universal identifier 51, the application name 52, and/or the human-readable application description.

The records 50 stored by the application knowledge repository 36 for a specific application may correspond to versions of the application available for and/or compatible with different application frameworks. For example, the records 50 may have an “App Framework” identifier 53 which may identify the application framework with which a version of the application is compatible and/or available. As illustrated in FIG. 2, the Calendara application may be available for Roku media players, Android devices, Wii gaming consoles, and iOS devices. The N-player application may be available for Google TV devices, Android devices and iOS devices. The “Petflix” application may be available for Android devices, iOS devices, Samsung TVs which support Samsung's App framework, Xbox gaming consoles, and Windows PCs.

The application knowledge repository 36 may store an application identifier 54 for each version of the application, and/or the records 50 may identify the application identifier 54 for each version of the application. The application knowledge repository 36 may store a source location 55 for each version of the application, and/or the records 50 may identify the source location 55 for each version of the application.

The application knowledge repository 36 may store other fields not shown in FIG. 2; for example, the application knowledge repository 36 may store a human-readable description of the application, a version number, an identifier for the application provider which provided the application, a list of one or more application classes, an operating system compatibility specification, and/or the like. Such fields may be stored for each version of the application known to the application knowledge repository 36.

The application knowledge repository 36 may obtain the records 50 from the application providers, such as the first application provider 31, the second application provider 32 and/or the third application provider 33. For example, a provider of the application knowledge repository may enable the application providers to submit information about applications. For example, the provider of the application knowledge repository 36 may provide a website which enables each of the application providers to enter input into a form which identifies an application created, developed, licensed and/or provided by the application provider. The form may enable the application provider to submit any of the fields included in the records 50 of the application knowledge repository 36. For example, one of the application providers may submit information about the Android version of the N-Player application, such as the application name 52, namely “N-Player”; the application framework 53, namely “Android”; the application identifier 54 by which the application may be identified within the Android application framework and/or application store; a version number; a list of one or more application classes; and/or the like.

Alternatively or additionally, the application knowledge repository 36 may obtain the records 50 from the application framework and/or the application store associated with the application framework. The records 50 may be provided with cooperation from the various application stores, may be extracted by the provider of the application knowledge repository 36 using a publicly accessible API, and/or may be obtained by analyzing packet data communicated between an application store and its associated on-device application, such as the “Android Market” application or Apple's “App Store” application. The provider of the application knowledge repository 36 may add one or more fields, such as application classes, whenever such fields may not be available from the application framework and/or the application store.

The application knowledge repository 36 may not require information about every application available through the application frameworks. For example, an application may be incapable of inter-application communication between devices, and such applications may not be relevant for the application knowledge repository 36. Therefore, the application knowledge repository 36 may store information about applications which are capable of inter-application communication and/or interaction. To this end, a provider of the application knowledge repository 36 may examine the application stores to determine the application names 52, the application framework 53 in which the application is available and/or compatible, the application identifiers 54, and/or other information for the records 50. Automatic tools may be developed and/or may be employed by the provider of the application knowledge repository 36 to perform these determinations.

A first application running on the control device 11 may have knowledge of the applications with which the first application is capable of communicating and/or interacting. As noted previously, this knowledge may take the form of a specific list of compatible applications and/or a list of one or more application classes.

The control device 11 and/or the first application may identify the other devices in the network 15, such as the first device 21, the second device 22 and/or the third device 23. For example, the control device 11 may use a UPnP discovery process and/or a similar process to determine the other devices in the network 15. The other devices in the network 15 may participate in the discovery process. As a result, each of the other devices in the network 15 may provide an identification, such as a device name, a model number, a manufacturer, device capabilities, and/or the like. The device capabilities may identify one or more application frameworks supported by the device.

In some embodiments, the control device 11 and/or the first application may initiate identification of the other devices in the network 15 in response to user input on the control device 11 and/or into the first application. In some embodiments, the control device 11 and/or the first application may perform and/or may complete the discovery process without additional user input on the control device 11 and/or into the first application subsequent to the user input which initiates the discovery process.

The control device 11 and/or the first application may identify the first device 21 and/or one or more application frameworks supported by the first device 21. The control device 11 may query the application knowledge repository 36 to identify a list of one or more applications. Each application on the list may be available for one of the application frameworks supported by the first device 21, and each application on the list may be an application with which the first application may communicate and/or interact. The query from the control device 11 to the application knowledge repository 36 may specify the applications with which the first application is capable of communicating and/or interacting.

In an embodiment, the query may list the universal identifier 51 for each of the applications with which the first application is capable of communicating and/or interacting. The application knowledge repository 36 may locate the records 50 for each of the applications using comparison of the universal identifier 51 to the records 50.

In another embodiment, the query may identify an application identifier for each of the applications with which the first application is capable of communicating and/or interacting. The query may identify the application framework 53 under which the application identifiers are relevant. For example, in the scenario illustrated in FIG. 2, the query may specify AppID[A2], and the query may further specify that AppID[A2] is relevant to the Android application framework. In response to the query, the application knowledge repository 36 may use the application identifiers 54, the application frameworks 53 and/or the records 50 to find a matching application identifier 54 which has the application framework 53 as “Android.” In this way, the application knowledge repository 36 may identify the Calendara application regardless of whether the application knowledge repository assigns and/or maintains universal identifiers 51. Accordingly, the application knowledge repository 36 may function without the universal identifiers 51 in such an embodiment.

In yet another embodiment, the query may list one or more application class identifiers. The application knowledge repository 36 may use the application class identifiers to identify the applications with matching class identifiers which are present in the records 50. For example, the query may list “DLNA compatible renderers” as an application class, and the application knowledge repository 36 may examine the records 50 to identify the applications which are associated with the same class. The application classes and the associated class identifiers may be defined by and/or standardized by the application knowledge repository 36. For example, each type of inter-application communication and/or interaction may be assigned an application class with a corresponding application class identifier.

The query from the control device 11 to the application knowledge repository 36 may specify one or more application frameworks which are supported by the device or devices with which the first application is attempting to communicate. The application knowledge repository 36 may filter a query response to include applications available for the one or more application frameworks specified by the query and/or the application identifiers 54 for the applications in the one or more application frameworks specified by the query. The application knowledge repository 36 may provide other information about the application and/or about the application versions for the one or more application frameworks specified by the query.

As a first example, the control device 11 may send a query to the application knowledge repository 36. The query may indicate the application identifier AppID[A2], may indicate that the application identifier is relevant to the Android application framework, and/or may indicate that the query targets iOS applications. The application knowledge repository 36 may examine the records 50 which may be stored by the application knowledge repository 36. For example, the application knowledge repository 36 may examine the records 50 to determine that the Android application identifier AppID[A2] corresponds to the Calendara application and/or determine that the Calendara application is available in and/or compatible with the target application framework, namely iOS.

In response to the query, the application knowledge repository 36 may provide the application identifier for Calendara in the iOS application framework, namely AppID[A4], to the control device 11. The application knowledge repository 36 may provide additional fields relevant to the iOS version of the Calendara application, as may be stored in and/or may be available from the records 50, to the control device 11. In an embodiment, the application knowledge repository 36 may provide the additional fields and the application identifier in the same query response.

As a second example, the control device 11 may send a query to the application knowledge repository 36 which indicates an application class, such as “DLNA 1.5 compatible renderers.” The query may further indicate that the query targets Google TV applications. The application knowledge repository 36 may examine the records 50 which may be stored by the application knowledge repository 36. For example, the application knowledge repository 36 may examine the records 50 to determine that the N-Player application belongs to the “DLNA 1.5 compatible renderers” class and/or determine that the N-Player application is available in and/or compatible with the target application framework, namely Google TV.

In response to the query, the application knowledge repository 36 may provide the application identifier for N-Player in the Google TV framework, namely AppID[B1], to the control device 11. The application knowledge repository 36 may provide other fields relevant to the Google TV version of the N-Player application, as may be stored in and/or available from the records 50, to the control device 11. In an embodiment, the application knowledge repository 36 may provide the additional fields and the application identifier in the same query response.

Therefore, the first application and/or the control device 11 may query the application knowledge repository 36 with a specification of compatible applications and/or a list of one or more application frameworks. The application knowledge repository 36 may process the query and may match the query fields to the records 50 to determine a list of compatible applications which are available for and/or compatible with the application frameworks specified by the query. The application knowledge repository 36 may provide the list of compatible applications to the control device 11 as a response to the query. The list may include the application identifiers 54 for each application in the list and/or additional information about the application as extracted from the records 50.

In some embodiments, the control device 11 and/or the first application may automatically generate the query and/or may automatically receive the query response in response to user input on the control device 11 and/or into the first application requesting initiation of the discovery process. In some embodiments, the control device 11 and/or the first application may automatically generate the query and/or may automatically receive the query response without additional user input on the control device 11 and/or into the first application subsequent to the user input which initiates the discovery process.

The control device 11 and/or the first application may communicate with the first device 21 to determine whether any of the compatible applications are installed and/or running on the first device 21. The control device 11 and the other devices may support a messaging protocol which allows such communication. The messaging protocol may be based on standard protocols, such as SOAP, HTTP and/or the like. Support for the messaging protocol may be built into the operating system of the device. Alternatively, support far the messaging protocol may be provided by an application which may be running on the device.

The control device 11 and/or the first application may use the messaging protocol to request that the first device 21 identify the status of one or more of the compatible applications which were identified by the application knowledge repository 36 in the query response. Based on the response from the first device 21, the control device 11 may request the first device 21 to install and/or run one of the compatible applications.

An example exchange between the control device 11 and the first device 21 using the messaging protocol is discussed hereafter. The direction of the corresponding message is illustrated with the “-<” symbol indicating that a message is sent from the control device 11 to the first device 21 or the “>-” symbol indicating that a message is sent from the first device 21 to the control device 11. For further clarity, the sending entity is listed in bold font, followed by the message type. Then, any additional fields included in the message are listed.

The control device 11 may query the application knowledge repository 36, and the response received by the control device 11 may provide application identifiers 54 for two applications compatible for the first device 21. The identifiers may be AppID[C2] and AppID[B3] for available iOS versions of the Petflix application and the N-Player application, respectively. The control device 11 may then request the first device 21 to provide the status of these two applications. For example, the control device 11 may send the following message to the first device 21.

-<

Control Device: Status_Request
Application list: AppID[C2], AppID[B3]

The application list specified by this message may provide a list of application identifiers 54 compatible with the application framework supported by the first device 21. In response, the first device 21 may use the application identifiers 54 to obtain and to provide the status of the applications which correspond to the listed application identifiers 54. For example, the first device 21 may send the following response message to the control device 11:

>-

First Device: Status_Response
AppID[C2] is not installed
App ID[B3] is installed, not running

This response from the first device 21 indicates that the Petflix application is not installed on the first device 21 and indicates that the N-Player application is installed but is not currently running on the first device 21. In the current example, the first application may have a preference to use a compatible application which is already installed so that the user of the first device 21 is not required to install a new application unless necessary. Therefore, the control device 11 and/or the first application may request the first device 21 to run the already installed N-Player application. For example, the control device 11 may send the following message to the first device 21:

-<

Control Device: Run_Request
Application: AppID[B3]

The first device 21 may respond by initiating running of the N-Player application and may indicate in a response message that the N-Player application is running. For example, the first device 21 may send the following response message to the control device 11:

>-

First Device: Run_Response
App ID [B3] is installed, running

At this point, the first application on the control device 11 may begin communicating and/or interacting with the N-Player application which is running on the first device 21. The messaging protocol may provide generic communication messages for this purpose so that the first device 21 and the first application running on the control device 11 may establish a data communication channel. For example, the data communication channel may be established by the following messages:

-<

Control Device: Open_AppData_Channel
Target Application: AppID[B3]

>-

First Device: Confirm_AppData_Channel
Target_ Application: AppID[B3]
Channel_Identifier: Channel_ID

The “Confirm_AppData_Channel” message from the first device 21 confirms that a generic data channel was opened for communication between the first application running on the control device 11 and the N-Player application running on the first device 21. The message may provide an identifier for the data channel. After the data channel is established, the two applications may communicate using generic data transfer messages which may use the identifier to reference the data channel. For example, the two applications may communicate using the following messages:

-<

Control Device: Send_Data_to_App
Channel_Identifier: Channel_ID
Data: [Application Specific Data]

>-

First Device: Send_Data_to_App
Channel_Identifier: Channel_ID
Data: [Application Specific Data]

The messages illustrated above represent various actions which may be supported in embodiments of the present invention. Each illustrative message may specify the primary data elements required to support the actions. The illustrative messages do not define a specific syntax for representing the message type identifiers or the additional fields. However, many known messaging protocols define message types, header fields and message bodies, such as HTTP, and one skilled in the art will recognize that creating a specific message syntax to represent the listed data elements may be straightforward. In addition, the messages may be encapsulated for delivery using well-known networking protocols, such as TCP.

The illustrative messages above specify the primary data elements necessary to enable the associated actions, but additional fields and data elements may be present in the messages. For example, sequence numbers may be added to the messages to enable correlation of responses to requests. As another example, additional descriptive fields for the specified applications may be sent in some of the messages; for example, the application version number may be sent in the “Status_Request” message to enable the first device 21 to provide the status of a particular version of the application. As yet another example, additional confirmation messages may be sent to indicate that certain messages were properly received. Such alterations may be made without departing from the scope of the present invention.

Some embodiments of the present invention may not use the messages for generic Application-to-Application data transfer, such as “Open_AppData_Channel,” “Confirm_AppData_Channel,” “Send_Data_to_App” and/or the like. In some embodiments, the first application may use the other messages of the messaging protocol to install and/or run a compatible application on the first device 21. When the compatible application is running, the two applications may communicate using their own application-specific protocols without utilizing any data channels arranged through the messaging protocol. For example, a DLNA-compatible application on the control device 11 may cause another DLNA-compatible application to be installed and/or run on the first device 21. Then, the two DLNA-compatible applications may communicate using the well-known DLNA and UPnP protocols.

To summarize, embodiments of the messaging protocol may have one or more of the following message types and descriptions. The control device 11 may send a “Status_Request” message to the first device 21 to request the status of one or more applications of the first device 21. The message may provide an application identifier for each of the applications. The application identifiers 54 may identify applications within an application framework supported by the first device 21. The control device 11 may receive a “Status_Response” message from the first device 21 which may provide the status of one or more applications in response to a “Status_Request” message. The “Status_Response” message may indicate whether each of the applications is installed on the first device 21 and/or whether each of the applications is running on the first device 21.

The control device 11 may send an “Install_{—} Request” message to the first device 21 to request that the first device 21 install an application, such as an application specified by an application identifier in the “Install_Request” message. The control device 11 may receive an “Install Response” message from the first device to indicate whether the application identified in an “Install_Request” message was installed.

The control device 11 may send a “Run_Request” message to the first device 21 to request that the first device 21 run an application, such as an application specified by an application identifier in the “Run_Request” message. The control device 11 may receive a “Run_Response” message from the first device 21 which may indicate whether the first device 21 initiated running the application identified in a “Run_Request” message.

The control device 11 may send an “Open_AppData_Channel” message to the first device 21 to request that the first device 21 open an application-to-application data channel. The “Open_AppData_Channel” message may use an application identifier to identify the application on the first device 21 to which the data channel is to be established. The control device 11 may receive a “Confirm_AppData_Channel” message from the first device 21 which may indicate whether the application-to-application data channel identified in an “Open_AppData_Channel” message was opened and/or identify a Channel_ID which may be used in subsequent message to indicate association with the application-to-application data channel.

The control device 11 may send a “Send_Data_to_App” message to the first device 21, and the control device 11 may receive a “Send_Data_to_App” message from the first device 21. A “Send_Data_to_App” message may transfer application-specific data. The control device 11 may send a “Close_AppData_Channel” message to the first device 21, and the control device 11 may receive a “Close_AppData_Channel” message from the first device 21. A “Close_AppData_Channel” message may close an application-to-application data channel, such as an application-to-application channel identified by a Channel_ID in the “CloseAppData_Channel” message.

Example scenarios follow hereafter to illustrate use of the system 10. The examples generally illustrate various ways in which the first application running on the control device 11 may use the application knowledge repository 36 and the messaging protocol to identify, install, run, communicate with, and/or interact with compatible applications on the other devices. Each of the steps disclosed hereafter may be optional for some embodiments of the corresponding method.

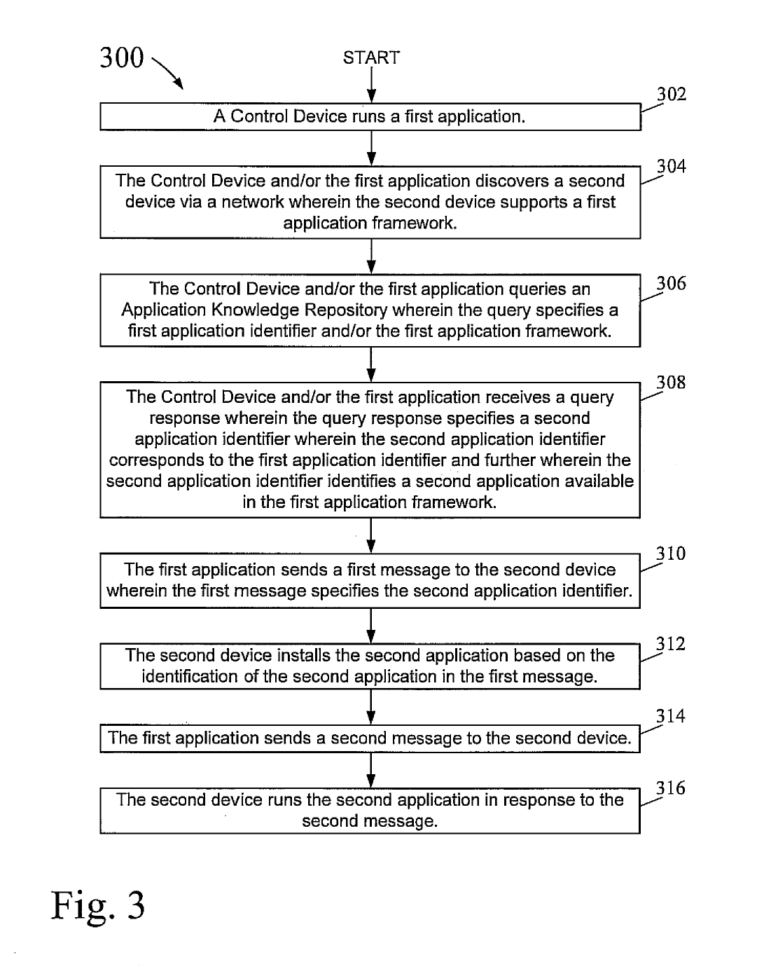

FIG. 3 generally illustrates a method 300 in an embodiment of the present invention. In an embodiment, the control device 11 may perform the steps of the method 300 by executing program instructions provided and/or stored by a non-transitory computer-readable medium, such as register memory, processor cache and Random Access Memory (RAM). The non-transitory computer-readable medium may be any computer-readable medium, the sole exception being a transitory, propagating signal.

At step 302, the control device 11 may run a first application. At step 304, the control device 11 and/or the first application may identify the second device 22 through the network 15, and the second device 22 may be capable of running applications from a first application framework. In some embodiments, the second device 22 may inform the control device 11 and/or the first application that the second device 22 is capable of running applications from the first application framework. In some embodiments, the second device 22 may inform the control device 11 that the second device 22 is capable of running applications from the first application framework without user input on the second device 22 directing the second device 22 to inform the control device 11 that the second device 22 is capable of running applications from the first application framework.

At step 306, the control device 11 and/or the first application may send a query to the application knowledge repository 36, and the query may specify a first application identifier and/or the first application framework. In an embodiment, the application identifier may be a universal identifier for an application such that the application identifier does not identify a specific application framework. In another embodiment, the application identifier may identify an application within a specific application framework.

At step 308, the control device 11 and/or the first application may receive a query response from the application knowledge repository 36 which may specify a second application identifier. The second application identifier may be based on the first application identifier and/or the application framework specified by the query, and the second application identifier may identify a second application available in and/or compatible with the first application framework.

In some embodiments, the second application may be a version of the first application available in and/or compatible with the first application framework. In these embodiments, the second application may be identical to the first application if the control device 11 supports the same application framework as the second device 22; otherwise, the second application may be a different version of the first application such that the second application is available for and/or compatible with the first application framework supported by the second device 22. In other embodiments, the second application may be a different application than the first application.

At step 310, the control device 11 and/or the first application may send a first message to the second device 22. For example, the first message may be an “Install_Request” message as previously defined herein. The first message may specify the second application identifier. At step 312, the second device 22 may install the second application from the first application framework based on the first message. For example, the second device may install the second application based on identification of the second application using the second application identifier provided by the first message. In some embodiments, the second device 22 may install the second application from the first application framework without user input on the second device 22 directing the second device 22 to install the second application.

At step 314, the control device 11 and/or the first application may send a second message to the second device 22. For example, the second message may be a “Run_Request” message as previously defined herein. The second message may specify the second application identifier. At step 316, the second device 22 may run the second application in response to the second message. In some embodiments, the second device 22 may run the second application without user input on the second device 22 directing the second device 22 to run the second application.

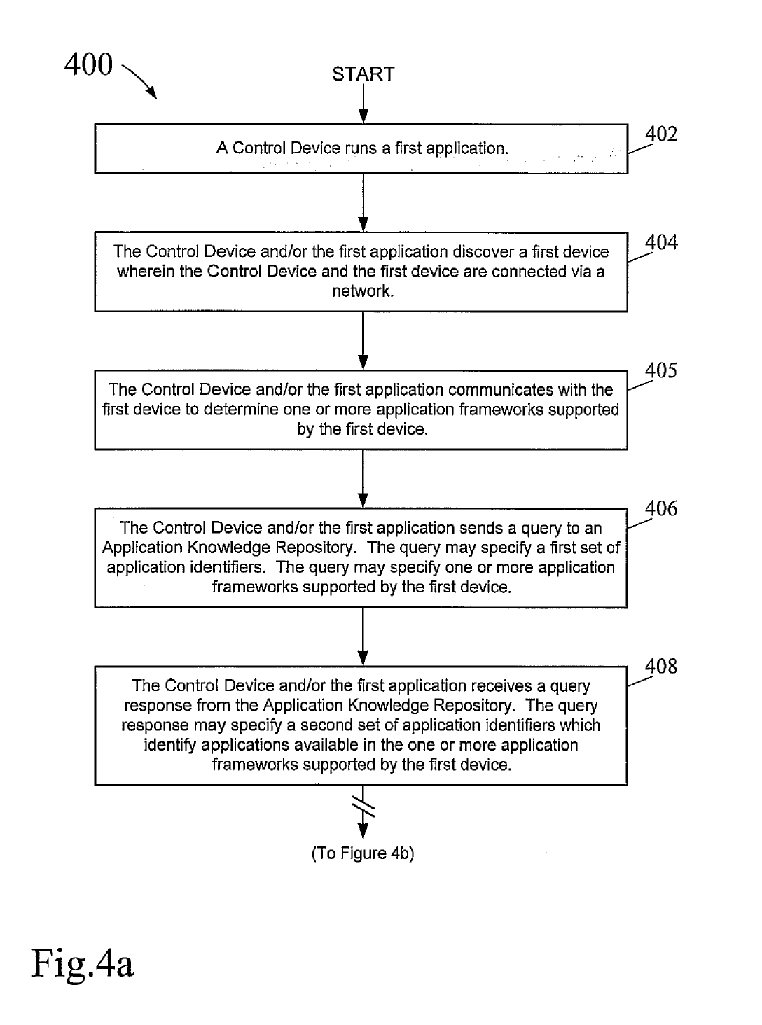

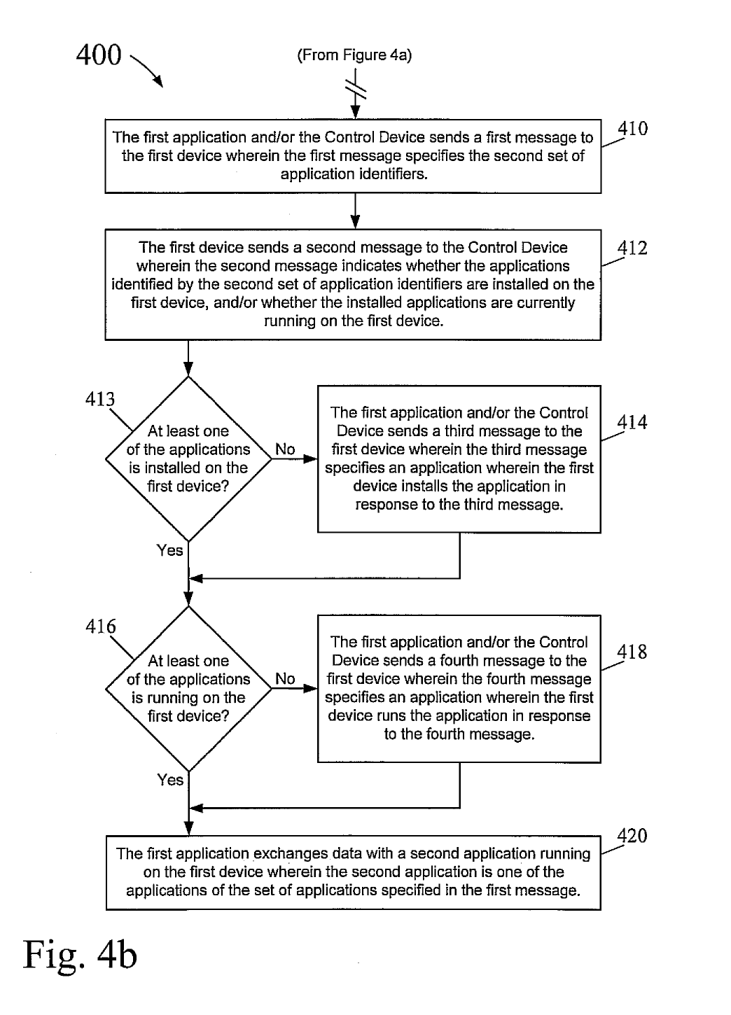

FIGS. 4a and 4b generally illustrate a method 400 in an embodiment of the present invention. In an embodiment, the control device 11 may perform the steps of the method 400 by executing program instructions provided and/or stored by a non-transitory computer-readable medium, such as register memory, processor cache and Random Access Memory (RAM). The non-transitory computer-readable medium may be any computer-readable medium, the sole exception being a transitory, propagating signal.

At step 402, the control device 11 may run a first application. At step 404, the control device 11 and/or the first application may identify the first device 21 through the network 15. At step 405, the control device 11 and/or the first application may communicate with the first device to determine one or more application frameworks supported by the first device 21. For example, the first device 21 may send a message to the control device 11 which identifies the one or more application frameworks supported by the first device 21. In some embodiments, the first device 21 may identify the one or more application frameworks supported by the first device 21 without user input on the first device 21 directing the first device 21 to identify the one or more application frameworks supported by the first device 21.

At step 406, the first application on the control device 11 may send a query to the application knowledge repository 36, and the query may specify first application identifiers and/or the one or more application frameworks supported by the first device 21. In an embodiment, one or more of the first application identifiers may be a universal identifier for an application such that the first application identifier does not identify a specific application framework. In an embodiment, one or more of the first application identifiers may identify an application in a specific application framework.

At step 408, the control device 11 and/or the first application may receive a query response from the application knowledge repository 36 which may specify second application identifiers. The second application identifiers may be based on the first application identifiers and/or the one or more frameworks supported by the first device 21 and/or identified in the query. The second application identifiers may identify applications available in and/or compatible with the one or more application frameworks supported by the first device 21.

In an embodiment, each of the second application identifiers may correspond to one of the first application identifiers. The application identified by the second application identifier may be a version of the same application identified by the corresponding first application identifier, and the version may be available for one of the application frameworks supported by the first device 21. In another embodiment, the control device may not support any of the application frameworks supported by the first device 21.

At step 410, the control device 11 and/or the first application may send a first message to the first device 21, and the first message may specify the second application identifiers which identify the applications available in the one or more application frameworks supported by the first device 21.

At step 412, the control device 11 and/or the first application may receive a second message from the first device 21, and the second message may indicate whether the applications specified by the second application identifiers are installed on the first device 21. The second message may indicate whether the installed applications are currently running on the first device 21.

The second message may indicate that none of the applications specified by the second application identifiers are installed on the first device 21. Then, the control device 11 and/or the first application may send a third message to the first device 21 at step 414. The third message may identify a selected application from the applications specified by the second application identifiers, and the first device 21 may install the selected application in response to the third message at step 414.

If none of the applications specified by the second application identifiers are running on the first device 21, the control device 11 and/or the first application may send a fourth message to the first device 21 at step 418. The fourth message may identify a selected application from the one or more installed applications which are not currently running on the first device 21, and the first device 21 may run the selected application in response to the fourth message.

At step 420, the first application on the control device 11 may exchange data with the selected application running on the first device 21. The selected application may be an application which was run in response to the fourth message, as described in step 418, or the selected application may be an application which was indicated in the second message to be already running, as described in step 412.

In an embodiment, the third message and the fourth message may be combined. The combined message may be sent from the control device 11 and/or the first application to the first device 21 after receipt of the second message from the first device 21. The combined message may identify a selected application from the applications specified by the second application identifiers, and the first device 21 may install and run the selected application in response to the combined message.

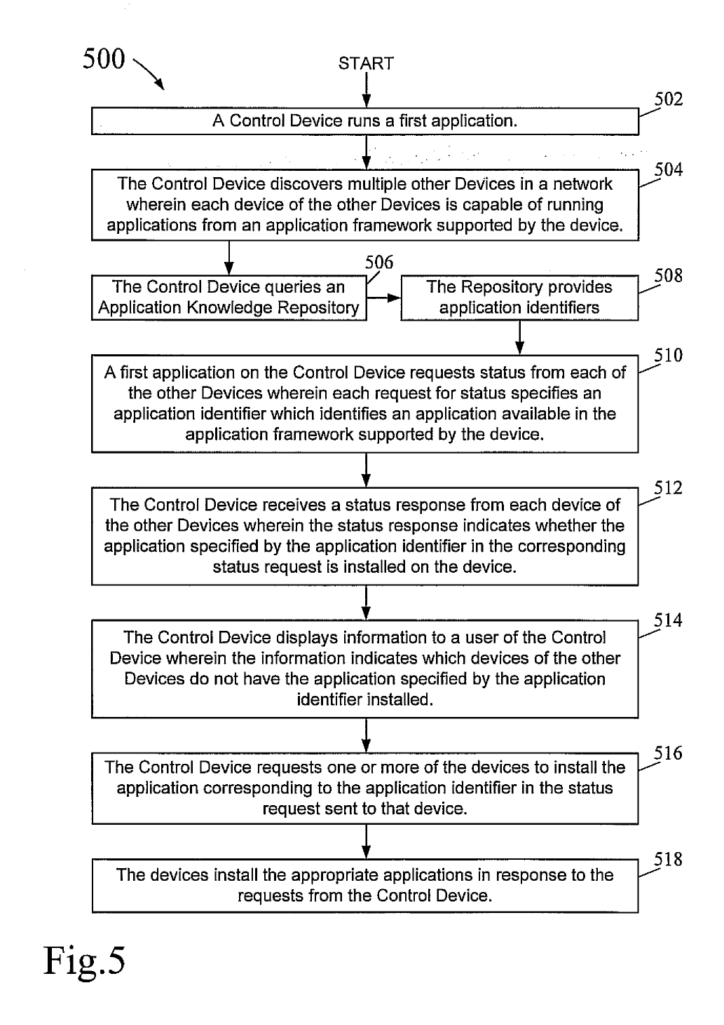

FIG. 5 generally illustrates a method 500 in an embodiment of the present invention. In an embodiment, the control device 11 may perform the steps of the method 500 by executing program instructions provided and/or stored by a non-transitory computer-readable medium, such as register memory, processor cache and Random Access Memory (RAM). The non-transitory computer-readable medium may be any computer-readable medium, the sole exception being a transitory, propagating signal.

At step 502, the control device 11 may run a first application. At step 504, the control device 11 and/or the first application may identify other devices in the network 15, such as the first device 21, the second device 22 and/or the third device 23. Each of the other devices may be capable of running applications from an application framework supported by the other device. For example, the first device 21 may be capable of running applications from a first application framework, the second device 22 may be capable of running applications from a second application framework, and/or the third device 23 may be capable of running applications from a third application framework. Each of the first application framework, the second application framework and the third application framework may be a different application framework relative to each other. Moreover, each of the first application framework, the second application framework and the third application framework may be a different application framework relative to a fourth application framework supported by the control device 11.

At step 506, the control device 11 and/or the first application may query the application knowledge repository 36 to obtain the application identifiers for the specific application framework supported by each of the other devices. For example, the control device 11 may query the application knowledge repository 36 to obtain the application identifiers for the first application framework, the second application framework, and/or the third application framework. The query may specify an application or a set of applications with which the first application is capable of communicating and/or interacting. The query may further specify one or more application frameworks; for example, the query may specify the application frameworks which correspond to the application frameworks supported by the other devices in the network 15, such as the first application framework, the second application framework, and the third application framework.

At step 508, the control device 11 and/or the first application may receive a query response from the application knowledge repository 36 which includes the application identifiers. The query response may provide identifiers corresponding to the application or set of applications specified in the query, and the identifiers may specify versions of these applications available for the application frameworks supported by the other devices in the network 15. For example, the query response may provide identifiers for the first application framework, the second application framework, and/or the third application framework. The identifiers provided by the query response may represent a subset of the applications specified in the query; for example, some of the applications specified by the query may not be available for the application frameworks specified by the query.

At step 510, the control device 11 and/or the first application may request a status from each of the other devices. For example, the control device 11 and/or the first application may send “Request_Status” messages to each of the other devices, and each of the “Request_{—} Status” messages may specify one or more application identifiers which identify an application available in the application framework supported by the device. For example, the control device 11 may send a “Request_{—} Status” message to the first device 21 which specifies an application identifier identifying an application available in the first application framework. The control device 11 may send a “Request_Status” message to the second device 22 which specifies an application identifier identifying an application available in the second application framework. The control device 11 may send a “Request_Status” message to the third device 23 which specifies an application identifier identifying an application available in the third application framework. In an embodiment, the applications may be the same application or different versions of the same application.

At step 512, the control device 11 and/or the first application may receive a message from each of the other devices, and the messages may provide the status of each requested application on each device. For example, the messages may be “Status_{—} Response” messages as defined previously herein. The “Status_{—} Response” messages may indicate whether the application specified by the application identifier in the corresponding “Status_{—} Request” message is installed on the other device which sent the “Status_Response” message. For example, the control device 11 may receive a “Status_Response” message from the first device 21 indicating whether the application specified by the application identifier in the corresponding “Request_Status” message is installed on the first device 21. The control device 11 may receive a “Status_Response” message from the second device 22 indicating whether the application specified by the application identifier in the corresponding “Request_Status” message is installed on the second device 22. The control device 11 may receive a “Status_Response” message from the third device 23 indicating whether the application specified by the application identifier in the corresponding “Request_ Status” message is installed on the third device 23.

At step 514, the control device 11 and/or the first application may display information to a user of the control device 11. The information may indicate which of the other devices do not have the application specified by the application identifier installed. At step 516, the control device 11 and/or the first application may send messages to one or more of the other devices requesting each device to install an application. For example, the messages may be “Install_{—} Request” messages as previously defined herein. The messages may request one or more target devices of the other devices to install the application corresponding to the application identifier in the “Request_Status” message sent to the one or more target devices. In an embodiment, the one or more target devices may be the other devices which sent “Status_{—} Response” messages indicating that the application was not installed. In another embodiment, the one or more target devices may be a subset of the other devices which sent “Status_Response” messages indicating that the application was not installed, and the subset may be specified by user input on the control device 11 and/or in the first application. At step 518, the one or more target devices may install the appropriate applications in response to the “Install_Request” message from the control device 11 and/or the first application.

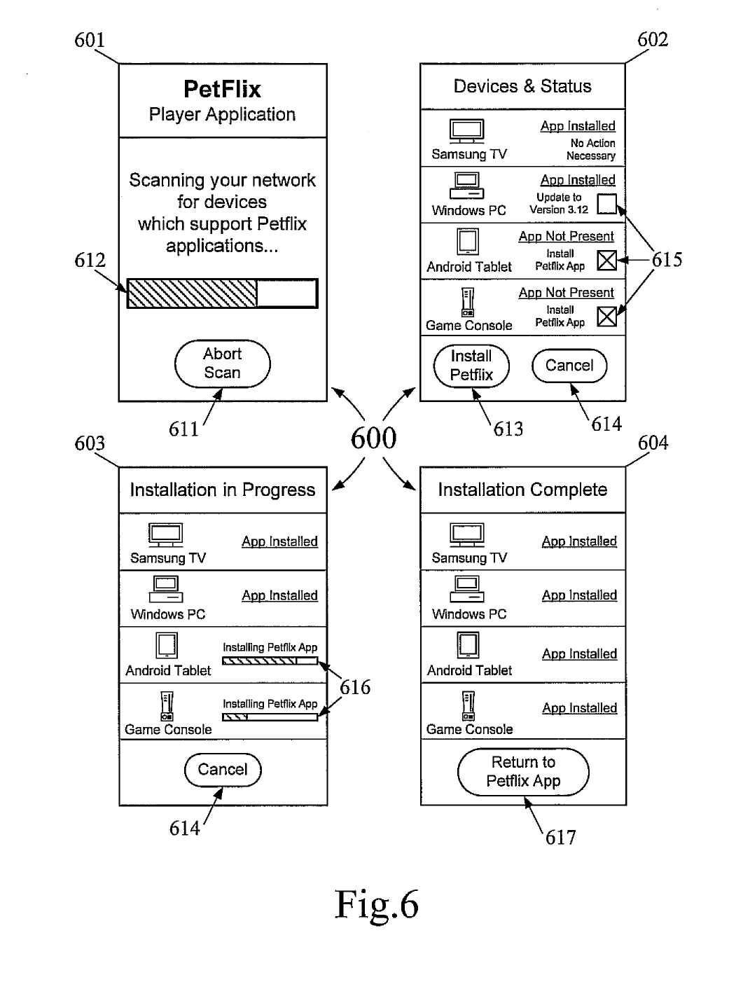

FIG. 6 generally illustrates an embodiment of a user interface 600 which may be implemented in the method 500. The first application may display the user interface 600 on the control device 11. The user interface 600 may display a first screen 601 which may visually indicate that the control device 11 and/or the first application are identifying other devices in the network 15, such as the first device 21, the second device 22 and/or the third device 23.

In an embodiment, the first screen 601 may have an “abort scan” option 611. If user input on the control device 11 selects and/or invokes the “abort scan” option 611, the control device 11 and/or the first application may stop identification of other devices in the network 15.

In an embodiment, the first screen 601 may display a status indicator 612 which may visually indicate a percentage of completion of identification of other devices in the network 15. The status indicator 612 may be a progress bar, a pie chart icon, a number and/or the like, and the present invention is not limited to a specific embodiment of the status indicator 612.

The user interface 600 may display a second screen 602 which may visually indicate the other devices in the network 15 identified by the control device 11. In an embodiment, the second screen 602 may be displayed after the first screen 601. In the example depicted in FIG. 6, the other devices in the network 15 may be a Samsung TV, a Windows PC, an Android tablet and/or a game console. The control device 11 may send “Request_Status” messages to the Samsung TV, the Windows PC, the Android tablet and/or the game console, and each of the “Request_Status” messages may specify an application identifier which identifies an application available in the application framework supported by the device. The control device 11 may receive a “Status_Response” message from the Samsung TV, the Windows PC, the Android tablet and/or the game console indicating whether the application specified by the application identifier in the corresponding “Request_Status” message is installed on the Samsung TV, the Windows PC, the Android tablet and/or the game console, respectively. The second screen 602 may visually indicate whether the application is installed or not installed on the Samsung TV, the Windows PC, the Android tablet and/or the game console.

The second screen 602 may have an “install” option 613. If user input on the control device 11 selects and/or invokes the “install” option 613, the control device 11 and/or the first application may instruct the other devices which do not have the application installed to install the application. In an embodiment, selection and/or invocation of the “install” option 613 may instruct each of the other devices which do not have the application installed to install the application. In another embodiment, the second screen 602 may enable the user to select one or more of the other devices which do not have the application installed. For example, the second screen 602 may display a selection control 615 next to each of the other devices which do not have the application installed. The other devices which have the application installed may not be selectable or invocable; for example, each of the other devices which have the application installed may not have the selection control 615. The user may select a subset of the other devices which do not have the application installed, such as by invoking the selection control 615 for each of the subset. Then, selection and/or invocation of the “install” option 613 may instruct the subset of the other devices which do not have the application installed to install the application.

In an embodiment, the second screen 602 may visually indicate that a more recent version of the installed application is available for one or more of the other devices on which the application is installed. For example, the second screen 602 may display text and/or graphics which visually indicate that a more recent version of the installed application is available for the other device. As another example, the second screen 602 may display the selection control 615 for each of the other devices for which a more recent version of the installed application is available. The user may select one or more of the other devices for which a more recent version of the installed application is available, such as by invoking the selection control 615 for the other device. Then, selection and/or invocation of the “install” option 613 may instruct the other device for which a more recent version of the installed application is available to install the more recent version of the application.

In an embodiment, the second screen 602 may provide a “cancel” option 614, and selection and/or invocation of the “cancel” option 614 may prompt the control device 11 and/or the user interface 600 to return to the first application.

The user interface 600 may display a third screen 603 after the “install” option 613 is selected and/or invoked, and the third screen 603 may indicate that installation of the application on the other devices is proceeding. In an embodiment, the user interface 600 may display the third screen 603 after displaying the first screen 601 and/or the second screen 602. The third screen 603 may display a status indicator 616 which may visually indicate a percentage of completion of installation of the application on each of the other devices. The status indicator 616 may be a progress bar, a pie chart icon, a number and/or the like, and the present invention is not limited to a specific embodiment of the status indicator 616.

The user interface 600 may display a fourth screen 604 after installation of the application on the other devices is completed. In an embodiment, the user interface 600 may display the fourth screen 604 after displaying the first screen 601, the second screen 602 and/or the third screen 603. The fourth screen 604 may visually indicate that installation of the application on the other devices is completed. For example, the fourth screen 604 may display text and/or graphics which indicate that installation of the application on the other devices is completed. The fourth screen 604 may provide a “return” option 617, and selection and/or invocation of the “return” option 617 may prompt the control device 11 and/or the user interface 600 to return to the first application.

The method 500 and the user interface 600 generally illustrate embodiments in which a first application running on one device may cause installation of compatible applications on other devices so that the utility of the first application and/or the utility of the network overall may be improved. For example, as illustrated in FIG. 6, the first application may be the Petflix application which may enable a user to view media content from the Petflix media service on a control device, such as a smartphone or other mobile device. The Petflix application on the control device may be capable of communicating with other versions of the Petflix application on other devices in the network. For example, the Petflix application on a smartphone may enable the user to search for, discover, and select videos from the Petflix media service using the smartphone. Then the Petflix application may enable the user to send a selected Petflix video over the network to another device, such as the Samsung TV or the gaming console for rendering.

When rendering Petflix media content on the other devices, the Petflix video service may require that rendering be performed using a proprietary Petflix application. For example, Petflix may require a secure transport technique supported only by the proprietary Petflix application, or Petflix may require advertisements to be displayed and/or tracked using a proprietary Petflix application. Therefore, a device which lacks the proprietary Petflix application may be incapable of and/or unsuitable for displaying Petflix media content, and, as a result, the Petflix application on the smartphone may not interact with other devices which lack the proprietary Petflix application. Thus, the method 500 and/or the user interface 600 may enable the Petflix application on the control device to discover the devices in the network which lack the Petflix application and for which a version of the Petflix application is available. The user may then install the Petflix application on those devices using the user interface 600 on a single device rather than separately using an application store in the user interface of each of the other devices to search for, discover, and install the Petflix application on each of the other devices.

A security model may be implemented in the system 10 to prevent a rogue application on the control device 11 from using the messaging protocol to perform unauthorized actions on another device in the network 15. Unauthorized actions may be actions performed without the knowledge and/or the permission of a user or an administrator of the other device. For example, a rogue application on the control device 11 may utilize the messaging protocol to determine which applications are installed on the first device 21 and may report such information to a third party without the knowledge and/or the permission of the owner of the first device 21. As another example, the rogue application may use the messaging protocol to install and/or run an application on the first device 21 without the knowledge and/or the permission of the owner of the first device 21.

For a first security model, the devices may be connected through a local network, such as a home network. The home network may be secured using a standard network security method, such as WEP, WPA and/or WPA2. The first security model may rely on the overall network security to prevent unauthorized devices from communicating within the local area network. However, inside the network the devices may be considered trustworthy, and messages from the messaging protocol may be exchanged and acted on inside the network without restriction.

In a second security model, the devices may require authorized pairing for messages from the messaging protocol to be exchanged and acted on. A first application on the control device 11 may utilize the messaging protocol to send a message to the first device 21. For example, the message may request the status of an application on the first device 21. The first device 21 may respond by displaying a warning message in the user interface of the first device 21. The first device 21 may request input from a local user and/or administrator. The requested input may approve a response to the message from the control device 11 and/or may authorize the first device 21 to respond to subsequent messages from the same control device 11 and/or the first application on the control device 11. The local user and/or administrator may authorize actions for each received message, such as sending a message requesting the status of an application, approving installation of an application, approving running of an application, and/or the like. Alternatively, the local user and/or administrator may provide blanket authorization to process and respond to future messages from the control device 11 and/or the first application.

In the second security model, the actions may be ordered by concern. For example, installing software on a device may be considered a greater concern relative to a status request. In an embodiment, the other device may require approval from a local user to install an application in response to a request from the control device 11. For example, the first device 21 may require approval from a local user of the first device 21 to install an application in response to a request from a control device 11. Actions which are a lesser concern, such as a status request, may not require approval from a local user of the other device.

In some embodiments, the other device may require input from a local user to install an application which requires payment to purchase the application. The local user may be required to authorize the purchase of the application. Authorization may require the local user to enter a password and/or provide payment information, such as a username, an account number, a credit card number, a credit card security code, and/or the like.

The first security model may be used in combination with the second security model. For example, a standard network security method, such as WPA2, may be employed to secure a home network according to the first security model, and the devices may require authorization according to the second security model.

Although the application knowledge repository 36 may be remote relative to the control device 11 and/or may be accessible through the internet 35, some embodiments may incorporate the application knowledge repository 36 into the control device 11 and/or into the first application running on the control device 11. Such a configuration may enable the records 50 to be stored in a database on the control device 11. The records 50 may be periodically updated through the internet 35, and/or the records 50 may be updated by installing an updated first application on the control device 11.

If the application knowledge repository is local to the control device 11, the method 300, the method 400 and/or the method 500 may be employed without explicitly querying an external application knowledge repository 36 and/or without explicitly receiving a query response from an external repository application knowledge repository 36. For example, one or more of the querying steps, such as step 306, step 406 and/or step 506, and/or one or more of the query response steps, such as step 308, step 408 and/or step 508, may be replaced with corresponding steps in which the control device 11 searches the records 50 in an internal database to determine the application identifiers and/or the other fields which would have been returned in a query response.

There are other notable variations of the methods previously set forth herein. First, the method 300, the method 400, and/or the method 500 may involve querying the application knowledge repository 36 using application identifiers to identify specific applications; however, each of these methods may be modified so that the queries are based instead on one or more application classes. For each application class listed in the query, the application knowledge repository 36 may examine the records 50 which may be stored by the application knowledge repository 36 to determine one or more applications which belong to the application class and/or which are available for the one or more application frameworks specified in the query. The application knowledge repository 36 may then respond to the query using the application identifiers for the applications which match at least one of the application classes and at least one of the application frameworks specified in the query.

Second, the method 300, the method 400, and/or the method 500 may be modified to use preferences known to the application running on the control device 11. For example, in method 400, the first application and/or the control device 11 may have preferences among the applications specified by the first set of application identifiers which are used to query the application knowledge repository 36 in step 406. The first application and/or the control device 11 may then associate the preferences with the applications identified by the second set of application identifiers returned in the query response in step 410.

For example, the first set of application identifiers may include UnivID[C] and UnivID[B] with a preference for UnivID[C] (Petflix) over UnivID[B] (N-Player). The query response returned in step 408 may include corresponding application-framework specific identifiers AppID[C1] (Petflix for Android) and AppID[B2] (N-Player for Android). Accordingly, the first application may transfer the original preferences to the query results, and, as a result, may prefer AppID[C1] over AppID[B2]. Thus, the first application may choose the Petflix application corresponding to AppID[C1] over the N-Player application corresponding to AppID[B2] when the first application is selecting the application specified for installation using the third message in step 414, selecting the application specified for running using the fourth message in step 418, and/or selecting the application specified for data exchange in step 420.

Third, the method 300, the method 400, and/or the method 500 may be modified to use the operating system compatibility specification previously described herein to ensure that an available version of an application is compatible with an operating system version running on one of the other devices. For example, the first application and/or the control device 11 may communicate with one of the other devices to identify the version of an operating system and/or an application framework present on the other device. Then, when the first application and/or the control device 11 queries the application knowledge repository 36 to obtain a list of application identifiers, the first application and/or the control device 11 may indicate the version of the operating system and/or application framework in the query.

The application knowledge repository 36 may compare the version of the operating system and/or application framework to the operating system version compatibility specification which may be available for each application version listed in the records 50. As a result, the application knowledge repository 36 may include in the query response only those application identifiers which correspond to application versions which are compatible with the version of the operating system and/or application framework supported by and/or indicated by the other device.

Finally, the method 300, the method 400, and/or the method 500 may be modified to enable the first application and/or the control device 11 to install multiple applications on one of the other devices. For example, the first application may support complex communication and/or interaction which may require two or more applications to be installed and running on one of the other devices. For example, the first device 21 may have a first set of application identifiers and a second set of application identifiers. The interaction model may require at least one of the applications identified by the first set of application identifiers and at least one of the applications identified by the second set of application identifiers. In the appropriate query step, the first application and/or the control device 11 may query the application knowledge repository 36 using the application identifiers from both the first set and the second set. Thus, candidate applications from each set which are available for one or more application frameworks supported by one of the other devices may be identified. The first application and/or the control device 11 may then request status from the other device, and may then request the other device to install and/or run available candidate applications corresponding to the first set and/or the second set as needed to support communication and/or interaction with the first application.

This modification may be based on two or more application classes rather than two or more sets of application identifiers. In this case, the first application and/or the control device 11 may query the application knowledge repository 36 using the two or more application classes to determine the applications from each class which are available for one or more application frameworks supported by the other device. The first application and/or the control device 11 may then use the messaging protocol to instruct the other device to install and/or to run at least one of the available applications from each of the two or more application classes. The available applications installed and/or running on the other device may support communication and/or interaction with the first application.

The two or more application classes may correspond to capabilities, features, functions and/or protocols with which the first application may communicate and/or interact. For example, the first application may be a DLNA Control Point application which may seek to install companion DLNA Server and DLNA Renderer applications on any of the other devices for which such applications are available. The first application may query the application knowledge repository 36 and may specify application classes “DLNA 1.5 compatible server” and “DLNA 1.5 compatible renderer” in the query to identify the applications which match these application classes and which are available for one or more target application frameworks. As a result, the first application may receive a query response which indicates that for a first application framework corresponding to first device 21, two separate applications must be installed on first device 21 to achieve both server and renderer functionality. Therefore, the first application may use the messaging protocol to instruct first device 21 to install and/or to run the two separate applications.

Furthermore, the first application may receive a query response which indicates that for a second application framework corresponding to second device 22, a single available application matches both of the application classes specified in the query. Therefore, the first application may use the messaging protocol to instruct the second device 22 to install the single application to achieve both server and renderer functionality. In this way, the first application and/or the control device 11 may determine the least number of applications to install and/or run on one of the other devices to support a communication and/or interaction model which requires the other device to support multiple application classes.

“Control Device” and “Other Devices” are merely roles which devices in the network 15 may take. These roles are defined to clearly specify the present invention. However, any device in the network 15 may be capable of performing the role of the “Control Device,” one of the “other Devices,” or both roles. In practice, most devices which are capable of one of the roles may be capable of the other role as well.

Various changes and modifications to the presently preferred embodiments described herein will be apparent to those skilled in the art. Such changes and modifications may be made without departing from the spirit and scope of the present invention and without diminishing its attendant advantages. Such changes and modifications are covered by the appended claims.

We claim:

1. A system comprising:
a network;
an application knowledge repository connected to the network wherein the application knowledge repository stores records having application identifiers corresponding to different versions of applications available for different application frameworks; and
a control device connected to the network wherein the control device transmits a query to the application knowledge repository wherein the query identifies a first application identifier corresponding to the version of a first application compatible with a first application framework and further wherein the query identifies a second application framework different than the first application framework wherein the application knowledge repository returns a query response to the control device identifying a second application identifier corresponding to the version of the first application compatible with the second application framework.

2. The system of claim 1 further comprising:
universal identifiers corresponding to each of the applications with which the first application is capable of interacting wherein the application knowledge repository stores the universal identifiers.

3. The system of claim 1 wherein the records specify application classes to which the applications belong.

4. The system of claim 1 wherein the application knowledge repository receives the records from an application provider.

5. The system of claim 1 wherein the application knowledge repository acquires the records from an application store.

6. The system of claim 1 wherein the application knowledge repository returns a query response to the control device identifying a source location of the first application.

7. The system of claim 1 further comprising:
a first device connected to the network wherein the control device queries the application knowledge repository to determine an application identifier appropriate to the first device.

8. A method of inter-application communication in a network, the method comprising the steps of:
running a first application on a control device to discover a first device in the network wherein the first device supports a first application framework;
querying an application knowledge repository with the control device wherein the query specifies a first application identifier;
receiving a query response by the control device wherein the query response specifies a second application identifier corresponding to the first application identifier and further wherein the second application identifier identifies a second application available in the first application framework;
sending a first message to the first device from the first application specifying the second application identifier; and
installing the second application on the first device in response to the first message wherein the first device installs the second application.

9. The method of claim B further comprising the step of:
communicating application frameworks supported by the first device to the control device wherein the first device informs the control device of the application frameworks supported by the first device.

10. The method of claim 8 wherein the application identifier used in the query is a universal application identifier and wherein the universal application identifier does not correspond to a specific application framework.

11. The method of claim 8 further comprising the step of:
sending a second message to the first device from the first application specifying the second application identifier; and
running the second application on the first device in response to the second message.

12. The method of claim 8 wherein the first application identifier specifies the first application running on the control device and wherein the second application identifier identifies a different version of the first application for the first application framework.

13. The method of claim 8 further comprising the step of:
requesting a status of the first device by the control device wherein the status specifies whether a particular application is installed on the first device.

14. The method of claim 8 further comprising the step of:
requesting a status of the first device by the control device wherein the status specifies whether a particular application is running on the first device.

15. The method of claim 8 wherein the control device does not support the first application framework that the first device supports.

16. The method of claim 8 further comprising the steps of:
requesting a status of an application on the first device by the control device; and
communicating a warning to a user of the first device requesting input from the user wherein the first device communicates the warning to the user in response to the status request.

17. The method of claim 8 further comprising the step of:
authorizing a response to the control device by user input on the first device.

18. The method of claim 8 wherein the query specifies multiple application identifiers and wherein the query response specifies multiple application identifiers which correspond to more than one application available for the first application framework.

19. The method of claim 8 wherein the application knowledge repository is incorporated into the control device.

20. The method of claim B wherein the application knowledge repository is located on a second device accessible to the control device via the network.

21. The method of claim 8 further comprising the step of:
exchanging data between the first application running on the control device and an instance of the second application running on the first device.

22. A method of inter-application communication in a network having a control device, the method comprising the steps of:
detecting a first device with the control device;
querying an application knowledge repository with the control device to determine an application appropriate to the first device wherein the application knowledge repository transmits a query response to the control device; and
installing an application on the first device wherein the application is identified in the query response and wherein the control device communicates with the first device to install the application.

23. A method of inter-application communication in a network having a control device, the method comprising the steps of:
running a first application on the control device to discover a first device in the network wherein the first device supports a first application framework;
querying an application knowledge repository with the control device wherein the query specifies an application class and the first application framework;
identifying an application which belongs to the application class and is available for the first application framework specified in the query;
providing a query response to the control device from the application knowledge repository specifying application identifiers for applications which belong to the application class and which are available for the first application framework specified in the query; and
installing an application on the first device wherein the application is one of the applications for which an application identifier was specified in the query response and wherein the control device communicates with the first device to install the application.

24. The method of claim 23 wherein the query specifies at least two application classes to determine the applications from each application class which are available for application frameworks supported by the first device and wherein the query response to the control device from the application knowledge repository specifies application identifiers for the applications which belong to each of the at least two application classes specified in the query, the method further comprising the step of:
instructing the first device to install an available application from each of the at least two application classes wherein the available applications installed on the first device support interaction with the first application.

25. The method of claim 23 wherein the query specifies at least two application classes to determine the applications from each application class which are available for application frameworks supported by the first device and wherein the query response to the control device from the application knowledge repository specifies an application identifier for a single application which belongs to both of the at least two application classes specified in the query, the method further comprising the step of:
instructing the first device to install the single application which belongs to both of the at least two application classes specified in the query.

26. A method of updating devices in a network, the method comprising the steps of:
running a first application on a control device;
identifying a plurality of devices in the network using the control device wherein each of the plurality of devices is capable of running applications from an application framework supported by each respective device;
querying an application knowledge repository using the control device to obtain application identifiers for applications appropriate to the respective application frameworks supported by each of the plurality of devices;
receiving a query response from the application knowledge repository by the control device wherein the query response provides the application identifiers;
requesting a status from each of the plurality of devices using the control device wherein the request for status sent to each device specifies one of the application identifiers provided in the query response;
receiving a message from each of the plurality of devices by the control device wherein each respective message provides the status of the application corresponding to the application identifier for which the request for status was sent to each respective device;
displaying information on the control device indicating which of the plurality of devices do not have the application specified by the application identifier installed;
requesting installation of an application on one of the plurality of devices; and
installing the application on the one of the plurality of devices in response to the installation request.

27. The method of claim 26 wherein one of the plurality of devices supports an application framework which is not supported by the control device.

28. The method of claim 26 wherein the query specifies a plurality of application identifiers and further wherein the application identifiers provided to the control device in the query response correspond to a subset of the plurality specified in the query.

29. The method of claim 26 further comprising the step of:
determining a subset of the plurality of devices to request installation of an application in response to user input on the control device.

30. The method of claim 26 wherein the query specifies an application class.

31. The method of claim 26 wherein the query specifies an application identifier.

32. The method of claim 26 further comprising the steps of:
communicating with one of the plurality of devices using the control device to identify a version of an operating system on the device;
querying the application knowledge repository with the control device to obtain a list of application identifiers wherein the control device indicates the version of the operating system in the query;
comparing the version of the operating system indicated in the query to an operating system version compatibility specification in the application knowledge repository; and
responding to the query wherein the application knowledge repository specifies for the one of the plurality of devices only those application identifiers which correspond to application versions which are compatible with the version of the operating system indicated by the device.

33. The method of claim 26 wherein the message received from each device indicates whether the application corresponding to the application identifier for which status was requested is installed on the device.

34. The method of claim 26 wherein the message received from each device indicates whether the application corresponding to the application identifier for which status was requested is running on the device.
